(19) United States
(12) Patent Application Publication
(10) Pub. No.: US 2009/0164238 A1
(43) Pub. Date: Jun. 25, 2009

(54) Apparatus and Method for Administration of Medications

(75) Inventor: Geof Auchinleck, Vancouver (CA)

Correspondence Address: HANCOCK HUGHEY LLP, P.O. BOX 1208, SISTERS, OR, 97759, US

(73) Assignee: Neoteric Technology, Limited

(21) Appl. No.: 12/083,392

(22) PCT Filed: Oct. 12, 2006
(86) PCT No.: PCT/CA2006/001676

§ 371 Date: Apr. 9, 2008

Related U.S. Application Data
(60) Provisional application No. 60/728,390, filed on Oct. 18, 2005.

(51) Int. Cl. G06Q 50/00; G06Q 10/00; G08B 21/00

(52) U.S. Cl. 705/2; 340/540

(57) ABSTRACT

Apparatus and methods to ensure the safe and effective administration of medication to patients are disclosed, including information about medication administration so that complete audit trails are recorded. The invention provides a guided process to the caregiver to ensure that the correct steps are taken in the correct order, and that all required data is collected, including means for adapting the guidance and data collection to suit the type of drug, to simplify the process for delivering relatively innocuous drugs, while ensuring that all safety measures are taken for relatively high-risk drugs. The invention includes novel means for ensuring that the caregiver is aware of correct route of administration of the drug.

### FIELD OF THE INVENTION

The present invention relates generally to the medical field and specifically to apparatus and methods to ensure the safe and effective administration of medication to patients, including collecting, storing and transmitting information about medication administration so that complete audit trails are recorded.

### BACKGROUND OF THE INVENTION

Administration of drugs to patients is a high-risk process. Delivery of the wrong drug, in the wrong dosage, by the wrong means or through the wrong route, can lead to serious injury to the patient, or even death. The risk of an error is particularly high in hospitals, where a caregiver may be dealing with several patients requiring many medications during a typical shift. In such an environment, there is a significant risk of medications being mixed up, or that important information is not collected at the time of administration. Several published studies have shown that a large proportion of medical errors do occur at this stage. For example, a study published in the Journal of the American Medical Association in 1995 reported that 38% of medication errors occur during administration (Leape L. L. et al. Systems analysis of adverse drug events. JAMA 1995; 274 35-43).

Several drug administration management systems are known in the art. Examples include Guardrails™ (Alaris Medical Systems Inc, San Diego Calif.), MedPoint™ (Bridge Medical Inc, Solana Beach Calif.), and wCareMed (CareFusion Inc, McLean Va.). All of these systems provide greatly improved safety by attempting to manage the ‘five rights’ of medication administration, those being ‘right patient’, ‘right drug’, ‘right dose’, ‘right route of administration’ and ‘right time’. The drawback of these systems is that they do not adapt the administration process to suit the wide range of different drugs that might be administered. For example, the GuardRails and MedPoint systems are very good at safely managing the delivery of intravenous drugs using automated infusion pumps, but require far too many steps and confirmations to be useful when administering more innocuous drugs.

It is recognized in clinical practice that some drugs will require the caregiver to take extra precautions, as these drugs could be harmful or fatal if wrongly administered. Other drugs do not require such rigid precautions, as mistakes in administration are less likely to cause harm. Despite this, it is desirable to ensure that all medications are properly administered, and that proper records are kept of all medications given.

Medication delivery systems known in the art do not provide means for adapting the medication delivery process to the level of risk inherent in each drug. Caregivers willingly adopt sophisticated medication administration systems when using high-risk drugs, but are less likely to use such systems for low-risk drugs. This leads to a double standard of care, in which some medications are delivered with a high level of control and others are not.

It is desirable to provide a medication administration system that adapts its operation to the risk level of the drug being administered.

Furthermore, one area of significant risk is the route of administration for drugs. For example, drugs intended for intravenous delivery could well be fatal to the patient if delivered intrathecally. For this reason, simply asking the caregiver to confirm the delivery route is not a sufficiently reliable safeguard. A better means for establishing the correct route of administration is needed.

### SUMMARY OF THE INVENTION

The current invention reduces the risk of delivering medications to the wrong patient, while ensuring that the correct drug is delivered through the right route. Advantageously, the invention provides a guided process to the caregiver to ensure that the correct steps are taken in the correct order, and that all required data is collected. Further, the invention provides means for adapting the guidance and data collection to suit the type of drug, to simplify the process for delivering relatively innocuous drugs, while ensuring that all safety measures are taken for relatively high-risk drugs.

In addition, the invention provides a novel means for ensuring that the caregiver is aware of correct route of administration of the drug.

### BRIEF DESCRIPTION OF THE DRAWINGS

These and other objects, features and advantages of the present invention will become apparent upon reference to the following detailed description of the exemplary embodiment presented herein and to the drawings wherein:

FIG. 1 is a schematic diagram of one possible apparatus for managing the delivery of blood to a patient.

FIG. 2 illustrates a flowchart describing the steps for administering a drug to a patient using the apparatus illustrated in FIG. 1.

### DETAILED DESCRIPTION OF THE INVENTION

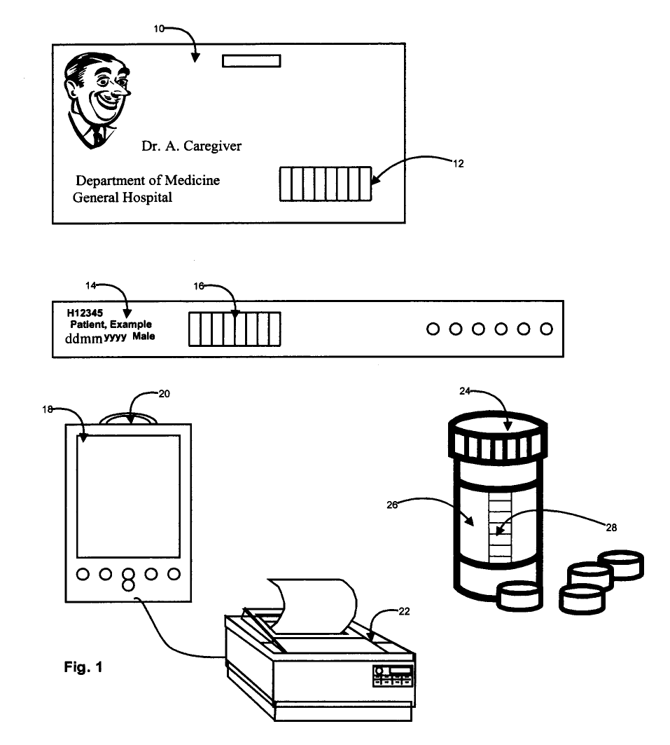

FIG. 1 illustrates apparatus suitable for implementing medication administration in accordance with the invention.

Each caregiver using the medication administration system has an identity means 10 which includes electronically readable caregiver code 12. Caregiver code 12 may be a linear or two-dimensional barcode using any one of many common barcode formats, such as code39, code128, Interleave 2 of 5, PDF 417, Matrix code, QR code, or others. Caregiver code 12 may also be any other type of electronically readable code means such as a Radio Frequency Identification (RFID) tag. Caregiver identity means 10 may be an employee identification card or similar item, in which caregiver code 12 is embedded, or to which caregiver code 12 is applied. In the exemplary embodiment presented herein, caregiver code 12 is a barcode label encoded with a unique number or letter combination, which is applied to the caregivers' employee identification card.

Each patient to be treated with medications wear identification wristband 14 which includes electronically readable patient code 16. Patient code 16 may be a linear or two-dimensional barcode using any one of many common barcode formats, such as code39, code128, Interleave 2 of 5, PDF 417, Matrix code, QR code, or others. Patient code 16 may also be any other type of electronically readable code means such as a Radio Frequency Identification (RFID) tag. In the exemplary embodiment presented herein, patient code 16 is a PDF-417 barcode, in which the patient's identity number, surname, forename, date of birth and sex are encoded.

In the exemplary embodiment presented herein wristband 14 is either a PDC Smart CompuBand or PDC Smart ScanBand (Precision Dynamics Corporation, www.pdcorp.com). These wristbands incorporate RFID chips and can be programmed and printed with any standard barcodes using printers like the Zebra Technologies R402 printer/programmer (Zebra Technologies, www.zebra.com). Although one possible embodiment of the invention uses RFID wristbands, an alternative embodiment uses wristbands having printed barcodes and no RFID chips. Wristbands that may be printed with barcodes are available from many sources, including the Z-Band from Zebra technologies. The Z-Band and similar products can be printed using commonly available thermal and thermal transfer label printers.

The apparatus according to the invention also includes a portable computer, preferably a Personal Digital Assistant (PDA) 48. PDA 18 includes reader 20 which is able to read caregiver code 12 and patient code 16. Reader 20 may be a barcode scanner, a barcode imager or an RFID reader. PDA 18 is also preferably equipped with a wireless network means, a touch screen, communication means for communicating with a portable printer, and is suitable for cleaning and disinfection. In the exemplary embodiment presented herein, PDA 18 is a Symbol PPT2748, a Symbol SPT2746, a Symbol MC50, a Symbol MC3000 (Symbol Technologies Ltd, www.symbol.com), an HHP Dolphin, or an Intermec Model 700.

Included on PDA 18 is software to implement the medication delivery process as hereinafter described.

The apparatus further Includes portable printer means 22 which can communicate with PDA 18 such that PDA 18 can cause printer 22 to print labels as required. In the exemplary embodiment presented herein, printer 22 is a Zebra QL-220 (Zebra Technologies, www.zebra.com) battery powered printer which may be connected to PDA 18 with a cable or through a wireless connection, such as a Bluetooth connection or an 802.11x connection.

Medications to be used in conjunction with the present invention may be packed in many different ways, including bottles, syringes, intravenous bags, boxes, blister packs and other forms. Each medication container 24 includes electronically readable medication code 28. Medication code 28 may be a linear or two-dimensional barcode using any one of many common barcode formats such as code39, code128, Interleave 2 of 5, PDF 417, Matrix code, QR code, or any form of UPC code which is commonly used to mark commercial products including medications. Medication code 28 may also be any other type of electronically readable code means such as a Radio Frequency Identification (RFID) tag. Medication code 28 may contain any unique identification number or letter and number combination.

Medication container 24 may also include compatibility label 26 which may be a two-dimensional barcode using any one of many two-dimensional barcode formats such as PDF 417, Matrix code, or QR code. Compatibility label 26 may also be any other type of electronically readable code means such as a Radio Frequency Identification (RFID) tag. In the preferred embodiment, compatibility label 26 contains identification information for the patient for whom the medication is intended, including the patient's identification number, last name, first name, date of birth and sex. Compatibility label 26 may also include the dose, route of administration, or expiry date for the medication, and may also include medication code 28 for confirmation as hereinafter described.

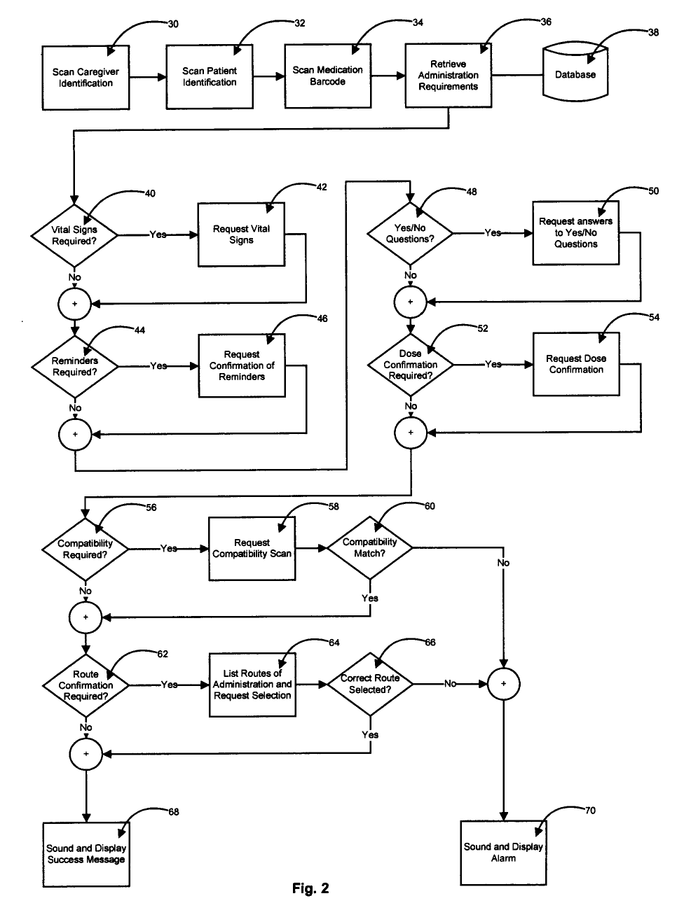

Referring to FIG. 2, software included on PDA 18 provides means for safely administering medications to a patient. At each step of the process, the software causes PDA 18 to display messages to the caregiver indicating the next step that the caregiver should perform. This forces the caregiver to follow a pre-defined procedure that is the same each time a medication is delivered. This has the effect of ensuring that even inexperienced caregivers follow all the correct steps when administering a medication as if they were highly trained.

The software on PDA 18 first causes PDA 18 to display a message asking the caregiver to read their caregiver code 12 (Step 30). To do this, the caregiver uses reader 20 of PDA 18 and either scans caregiver code 12 (if caregiver code 12 is a barcode) or brings reader 20 within range of caregiver code 12 (if caregiver code 12 is an RFID tag).

When a caregiver code is successfully read, PDA 18 displays a message requesting the caregiver to read patient code 16. Using reader 20 of PDA 18, the caregiver either scans patient code 16 (if patient code 16 is a barcode) or brings reader 20 within range of patient code 16 (if patient code 16 is an RFID tag) (Step 32). PDA 18 displays the patient identification information encoded in patient code 16. In the exemplary embodiment presented herein, this display includes the patient's identification number, surname, forename, date of birth and sex. PDA 18 displays a message asking the caregiver to confirm that the patient information is correct.

If the caregiver is satisfied that the information read from wristband 14 is correct, they press a button on the touch screen of PDA 18 to confirm that they have checked the information.

PDA 18 now displays a message asking the caregiver to scan medication code 28 on medication container 24 (Step 34). Medication code 28 can be any barcode on medication container 24 that provides a unique identifier for the medication. The barcode may be attached to a single dose of the medication, or may be the common UPC barcode printed on the medication packaging which is commonly used for retail inventory control.

The software on PDA 18 now searches database 38, which is stored on PDA 18 to find the administration requirements for the medication associated with medication code 28 (Step 36). Once an entry is located in the database, PDA 18 will use this information to determine which questions and instructions should be given to the caregiver as hereinafter described.

If the administration requirements retrieved from database 38 indicate that the patient's vital signs must be recorded prior to administration, (Step 40), PDA 18 displays a message asking the caregiver to enter the patient's vital signs using the touch screen of PDA 18 (Step 42). The vital signs are recorded in database 38. If vital signs are not required for the medication identified by medication code 28, this step is skipped.

If the administration requirements retrieved from database 38 indicate that the caregiver must acknowledge certain reminders prior to administration, (Step 44), PDA 18 displays a list of reminders retrieved from database 38 and displays a message asking the caregiver to confirm each reminder using the touch screen of PDA 18 (Step 46). Confirmation of the reminders is recorded in database 38. If reminders are not required for the medication identified by medication code 28, this step is skipped.

If the administration requirements retrieved from database 38 indicate that the caregiver must answer certain Yes/No questions prior to administration, (Step 48), PDA 18 displays a list of questions retrieved from database 38 and displays a message asking the caregiver to answer each Yes/No question using the touch screen of PDA 18 (Step 50). The answers provided by the caregiver are stored in database 38. If Yes/No questions are not required for the medication identified by medication code 28, this step is skipped.

If the administration requirements retrieved from database 38 indicate that the caregiver must confirm the medication dose prior to administration, (Step 52), PDA 18 displays a message asking the caregiver to enter the dose of the medication to be delivered using the touch screen of PDA 18 (Step 54). Confirmation of the dose is recorded in database 38. If dose confirmation is not required for the medication identified by medication code 28, this step is skipped.

In an alternate embodiment of the current invention, dose information for the medication identified by medication code 28 is retrieved from database 38. The dose information entered by the caregiver is compared to the dose information retrieved from database 38. If the dose information from database 38 does not match the dose information entered by the caregiver, the software on PDA 18 causes PDA 18 to display a warning and emit an alarm sound.

If the administration requirements retrieved from database 38 indicate that the caregiver must scan a compatibility label prior to administration, (Step 56), PDA 18 displays a message asking the caregiver to scan compatibility label 26 attached to medication container 24 (Step 58). When compatibility label 26 is scanned, the software on PDA 18 will compare the patient information encoded in compatibility label 26 to the patient information read from the patient's wristband in step 32 (Step 60). If the patient information does not match, PDA 18 displays a warning message and sounds an alarm (Step 70).

In an alternate embodiment of the current invention, (not illustrated in FIG. 2), the software on PDA 18 also compares the medication code encoded in compatibility label 26 to medication code 28 scanned in step 34. If the medication code from compatibility label 26 does not match medication code 28, it is likely that compatibility label 26 was placed on the wrong medication container, in which case PDA 18 displays a warning message and sounds an alarm.

If a compatibility label scan is not required for the medication identified by medication code 28, the compatibility label checking step is skipped.

If the administration requirements retrieved from database 38 indicate that the caregiver must confirm the route of administration for the medication (Step 62), PDA 18 displays a list of typical administration routes on the screen along with a message asking the caregiver to choose the correct route of administration (Step 64). When the caregiver chooses a route of administration, the software on PDA 18 compares the chosen route to the route of administration retrieved from database 38. If the routes of administration do not match, PDA 18 displays a warning message and sounds an alarm (Step 70).

If confirmation of the route of administration is not required, this step is skipped.

Provided that none of the previous steps have caused the display of an alarm message (Step 70), the software on PDA 18 displays a success message to the caregiver, informing them that the medication administration may now proceed (Step 68). When the success message is displayed, a record of the medication administration is stored in database 38.

If any step results in the display of an alarm message (Step 70), a record of the error is stored in database 38.

Consideration of the steps described above will show that the present invention permits an adaptive approach to medication delivery, in which the steps to be followed are determined by the medication to be delivered. For example, for a very low-risk medication, the administration requirements stored in database 38 may indicate that none of the following steps are required; the caregiver needs only to scan their own identification (Step 30), the patient's identification (Step 32) and the medication barcode (Step 34) to complete the process. Alternately, for a high-risk medication, the caregiver may be required to execute all steps of the process. Other medications may require some steps but not others.

Many alterations and modifications to the present invention will be obvious to one skilled in the art. For example, the need to store dose or route of administration information in database 38 may be obviated if this information is encoded in compatibility label 26. In such an embodiment of the invention, the dose and route of administration entered by the caregiver can be checked against those encoded in compatibility label 26.

Another variation of the present invention may include checking of the expiry date of the medication, recording the lot number of the medication, or providing specific instructions to the caregiver regarding the medication delivery, therefore, the present invention should be limited only by the scope of the appended claims.

1.-10. (canceled)

11. A method for ensuring the correct route of administration for a medication, comprising the steps of:
a. pre-determining the correct route of administration for a medication;
b. providing to a caregiver a list of medication administration routes;
c. causing the caregiver to select one of the listed medication administration routes
d. comparing the selected medication administration route to the pre-determined medication administration route; and
e. warning the caregiver if the pre-determined medication administration route does not match the selected medication administration route.

12. The method according to claim 11 including the steps of
a. providing a patient with identification means comprising electronically readable indicia, wherein the indicia includes the patient's identification; and
b. providing the medication intended for the patient with compatibility label means comprising electronically readable indicia, wherein the indicia for the compatibility label means includes the patient's identification and the route of administration for the medication.

13. The method according to claim 12 including providing a caregiver means to electronically read the patient identification means and the compatibility label means.

14. The method according to claim 13 including comparing the patient's identification means and the compatibility label means and warning the caregiver if the patient's identification means and the compatibility label means do not match.

15. The method according to claim 11 including the steps of:
a. marking medications with electronically readable indicia, wherein the indicia includes a unique code for each medication type;
b. for each medication type, pre-determining what additional information should be collected when the medication is administered;
c. for each medication type, establishing procedures to be followed when the medication is administered;
d. providing means for reading the electronically readable indicia on a medication;
e. requiring a caregiver to supply additional information as pre-determined for the medication; and
f. requiring the caregiver to follow procedures as pre-determined for the medication.

16. The method according to claim 15 in which the additional information comprises the patient's vital signs.

17. The method according to claim 16 in which the additional information includes answers to questions, and wherein the questions are pre-determined for the medication type.

18. The method according to claim 15, wherein the procedures to be followed include confirming that a series of tasks pre-determined for the medication type are complete.

19. The method according to claim 15, wherein the procedures to be followed include confirming the expiry date of the mediation.

20. The method according to claim 15, wherein the procedures to be followed include confirming the route of administration of the medication.

21. A method for ensuring the correct route of administration for a medication, comprising the steps of:
a. providing a patient with identification means comprising electronically readable indicia, wherein the indicia includes the patient's identification;
b. providing the medications intended for the patient with compatibility label means comprising electronically readable indicia, wherein the indicia for the compatibility label means includes the patient's identification and the route of administration for the medication;
c. providing a caregiver means to electronically read the patient identification means and the compatibility label means;
d. comparing the patient identification read from the patient identification means to the patient identification read from the compatibility label means and warning the caregiver if they do not match;
e. providing the caregiver with a list of medication administration routes, wherein the list includes the route of administration read from the compatibility label means;
f. requiring the caregiver to select a route of administration from the list of medication administration routes;
g. comparing the selected route of administration to the route of administration read from the compatibility label means; and
h. warning the caregiver if the selected route of administration is different from the route of administration read from the compatibility label means.

22. An adaptive medication delivery management system comprising:
means for identifying patient;
means for identifying medication; and
means for requesting input from a caregiver and recording responses, wherein the caregiver is asked to respond to questions specific to the particular medication.
